(19) United States
(12) Patent Application Publication
(10) Pub. No.: US 2021/0319449 A1
(43) Pub. Date: Oct. 14, 2021

(54) METHOD AND SYSTEM FOR DISPLAYING SECURITY RISK VALUE OF ONLINE PAYMENT BY COLOR

(71) Applicant: CIENET TECHNOLOGIES (BEIJING) CO., LTD., Beijing (CN)

(72) Inventor: Linghong CHEN, Beijing (CN)

(73) Assignee: CIENET TECHNOLOGIES (BEIJING) CO., LTD., Beijing (CN)

(21) Appl. No.: 17/304,743

(22) Filed: Jun. 25, 2021

Related U.S. Application Data
(63) Continuation of application No. PCT/CN2019/126863, filed on Dec. 20, 2019.

(30) Foreign Application Priority Data
Dec. 25, 2018 (CN) 201811593606.5

(51) Int. Cl. G06Q 20/40; G06T 11/00; G06K 19/06; G06Q 20/38

(52) U.S. Cl. CPC G06Q 20/4016; G06T 11/001; G06K 19/06037; G06K 19/06112; G06Q 20/3276; G06Q 20/4014; G06Q 20/384; G06K 2019/06225; G06K 19/0614

(57) ABSTRACT

A method and system for displaying a security risk value of online payment by a color. The method comprises the following steps: obtaining a risk value parameter of an online payment risk value, and allocating a color channel to each risk value parameter; during payment, calculating a brightness value of each color channel according to payment information; and if the brightness value of the color channel is greater than a set security risk value, carrying out payment early warning. According to the method, a security state of the current online payment is displayed by an obvious color, and a security risk can be prompted and warned before the online payment, thereby improving payment security.

### TECHNICAL FIELD

The present invention relates to a method for displaying a security risk value of online payment by color, and further relates to a system for realizing the method.

### RELATED ART

E-commerce has been more and more widely used in various commercial trade activities. The so-called e-commerce refers to a business operation mode for realizing online shopping of customers, online transactions and online electronic payment between merchants, as well as various commercial activities, transaction activities, financial activities and related comprehensive service activities based on browsers and server application modes in the open Internet network environment in commercial trade activities.

At present, the online electronic payment (online payment) has been already a part of everyone's life. However, the online payment also increases potential security risks while providing convenience. The security bottleneck in a settlement process of the online payment has always been an obstacle in development of e-commerce (online transactions). Especially for current online/mobile payments, a payer will directly complete the payment after confirming that the payment identity verification is successful. Even if there are any doubts found in subsequent transaction processes, due to an irreversible payment process (no security buffer), the payer has paid the money.

Therefore, as an only result, the payer needs to negotiate with the payee to refund the money, or, even more unfortunately, the payer's fund is defrauded, causing benefit loss.

In order to solve the above-mentioned problems, many online secure payment methods have been generated to enhance the security of an online payment process, but there are few prompts and warnings for the security risks before the online payment.

### SUMMARY

In view of the deficiencies in the prior art, the first technical problem that the present invention needs to solve is to provide a method for displaying a security risk value of online payment by color.

Another technical problem that the present invention needs to solve is to provide a system for displaying a security risk value of online payment by color.

To achieve the foregoing objective of the present invention, the following technical solutions are used in the present invention.

According to a first aspect of the embodiments of the present invention, a method for displaying a security risk value of online payment by color is provided, including the following steps:

acquiring a risk value parameter of an online payment risk value, and allocating one color channel for each risk value parameter; and

during payment, calculating a brightness value of each color channel according to payment information, and

performing payment prewarning when the brightness value of a color channel is greater than a set security risk value.

Preferably, the risk value parameter comprises a trust risk degree, a strange degree and a limit.

Preferably, the during payment, calculating a brightness value of each color channel according to payment information, and performing payment prewarning when the brightness value of a color channel is greater than a set security risk value comprises the following steps:

during payment, determining a brightness value of the color channel corresponding to the limit according to a payment amount, and displaying the payment amount by a color corresponding to the brightness value of the color channel;

after the payment amount is confirmed, respectively determining brightness values of the color channels corresponding to the trust risk degree and the strange degree, and respectively displaying the trust risk degree and the strange degree by colors corresponding to the brightness values of the color channels; and

comparing the brightness values of the color channels corresponding to the limit, the trust risk degree and the strange degree with the set security risk value, and when the brightness values of the color channels are greater than the set security risk value, performing payment prewarning.

Preferably, the during payment, determining a brightness value of the color channel corresponding to the limit according to a payment amount, and displaying the payment amount by a color corresponding to the brightness value of the color channel comprises the following steps:

presetting a small-value deal amount threshold and a large-value deal amount threshold;

acquiring a payment amount of a user; if the payment amount is less than the small-value deal amount threshold, indicating that the brightness value of the color channel corresponding to the limit is a minimum value; if the payment amount is greater than the large-value deal amount threshold, indicating that the brightness value of the color channel corresponding to the limit is a maximum value; otherwise, calculating the brightness value of the color channel corresponding to the limit by using the following formula:

$$B 1 = \frac{P}{H} \times ( M 1 - T 1 ) ;$$

where B1 is the brightness value of the color channel corresponding to the limit; P is the payment amount; H is the large-value deal amount threshold; M1 is the maximum value of the brightness value of the color channel corresponding to the limit; and T1 is the minimum value of the brightness value of the color channel corresponding to the limit; and displaying the payment amount by the color corresponding to the brightness value of the color channel.

Preferably, the method for displaying a security risk value of online payment by color further comprises the following steps:

if the brightness value of the color channel of the limit corresponding to the payment amount is greater than the large-value deal amount threshold, performing prewarning reminding on a payment interface, wherein the prewarning reminding is one or two of characters and speeches.

Preferably, when a two-dimensional bar code is used for payment, a payment two-dimensional bar code is displayed by the color corresponding to the brightness value of the color channel.

Preferably, the determining a brightness value of the color channel corresponding to the trust risk degree comprises the following steps:

acquiring real name authentication time and a historical number of complaints of a payee;

calculating the trust risk degree of payment according to the real name authentication time and the historical number of complaints of the payee by using the following formula:

$$R = ( 1 - V ) \times {Q}_{V} + \frac{T}{2} \times {Q}_{T} ;$$

where R is the trust risk degree; V is a real name authentication value; Q_{V} is a weight value of the real name authentication value; T is the historical number of complaints; and Q_{T} is a weight value of the historical number of complaints; and

calculating the brightness value of the color channel corresponding to the trust risk degree:

R1=R×(M2−T2);

where R1 is the brightness value of the color channel corresponding to the trust risk degree; R is the trust risk degree; M2 is a maximum value of the brightness value of the color channel corresponding to the trust risk degree; and T2 is a minimum value of the brightness value of the color channel corresponding to the trust risk degree.

Preferably, the determining a brightness value of the color channel corresponding to the strange degree comprises the following steps:

acquiring a first familiarity according to an affinity between a payer and a payee;

acquiring a second familiarity according to a payment record of the payer;

calculating a strange degree according to the first familiarity and the second familiarity by using the following formula:

G=1−(a×Qa+b×Qb).

where G is the strange degree; a is the first familiarity; Qa is a weight value of the first familiarity; b is the second familiarity; and Qb is a weight value of the second familiarity; and

calculating the brightness value of the color channel corresponding to the strange degree.

Preferably, in the acquiring a first familiarity according to an affinity between the payer and the payee, the following formula is used for calculation:

$$a = \frac{{\sum }_{i = 1}^{N} {S}_{i} \times {Q}_{i}}{{\sum }_{i = 1}^{N} {Q}_{i}} ;$$

where a is the first familiarity; N is a total number of kinds of social software that the payer and the payee are friends in contacts; Sᵢ is the affinity between the payer and the payee in the ith kind of social software, in the embodiments provided by the present invention, the affinity between the payer and the payee in the ith kind of social software is determined by whether the payee is a friend in contacts of the payer; and Qᵢ is a weight value of the ith kind of social software.

According to a second aspect of the embodiments of the present invention, a system for displaying a security risk value of online payment by color is provided, including a processor and a memory. The memory stores a computer program operable on the processor. The computer program, when executed by the processor, realizes the following steps:

acquiring a risk value parameter of an online payment risk value, and allocating one color channel for each risk value parameter; and

during payment, calculating a brightness value of each color channel according to payment information, and

performing payment prewarning when the brightness value of a color channel is greater than a set security risk value.

The method for displaying the security risk value of online payment by color provided by the present invention comprises the following steps: acquiring a risk value parameter of an online payment risk value, and allocating one color channel for each risk value parameter; associating the risk value parameter that affects the online payment with a color; and during payment, calculating a brightness value of each color channel according to payment information, and performing payment prewarning when the brightness value of a color channel is greater than a set security risk value. The method shows a security state of current online payment by clear colors, and can prompt and prewarn a security risk before the online payment, thereby improving the security of payment.

### BRIEF DESCRIPTION OF THE DRAWINGS

FIG. 1 is a flowchart of a method for displaying a security risk value of online payment by color provided by the present invention;

FIG. 2 is a schematic diagram of showing payment interfaces of different payment amounts in one embodiment provided by the present invention;

FIG. 3 is a schematic diagram of displaying a security risk value by color according to a trust risk degree, a strange degree and a limit in one embodiment provided by the present invention;

FIG. 4 is a schematic diagram of triangular exhibition of security risk of a payee in one embodiment provided by the present invention; and

FIG. 5 is a schematic structural diagram of a system for displaying a security risk value of online payment by color provided by the present invention.

### DETAILED DESCRIPTION

The technical content of the present invention is described in detail below with reference to the accompanying drawings and specific embodiments.

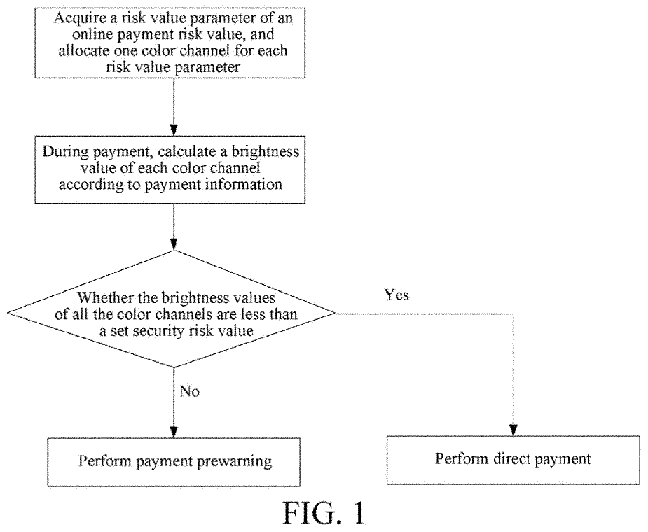

As shown in FIG. 1, a method for displaying a security risk value of online payment by color provided by the present invention comprises the following steps: first, acquiring a risk value parameter of an online payment risk value, and allocating one color channel for each risk value parameter; and during payment, calculating a brightness value of each color channel according to payment information; and performing payment prewarning when the brightness value of a color channel is greater than a set security risk value. The method shows a security state of current payment by clear colors, and can prompt and prewarn a security risk before the online payment, thereby improving the vigilance of a user and reducing transaction behaviors with potential security hazard to a certain extent. This process is specifically described in detail below.

S1: A risk value parameter of an online payment risk value is acquired, and one color channel is allocated for each risk value parameter.

In the embodiments provided by the present invention, the risk value parameter of the online payment risk value comprises a trust risk degree, a strange degree, and a limit.

The trust risk degree may be acquired from a server by determining, by means of a network, whether a payee has completed real name authentication, whether the payee has been complained, etc. If the security level data of a user of the other party (the payee) has been at an insecure level, the method provided by the present invention is used to mark out this by varying colors according to the trust risk degree.

The strange degree (an antonymy of the familiarity) may be acquired according to whether a payee is on mobile phone contacts, WeChat contacts, Taobao contacts, Alipay contacts, QQ contacts, etc., whether the payee has a past payment record, and the like.

The limit may be a preset payment amount threshold, and is, for example, set to be a large-value deal amount threshold H. A payment amount that is greater than the large-value deal amount threshold will be warned. Whether to warn may also be determined by accumulating whether the amount of the same payee exceeds the preset threshold of the limit in combination with a transaction frequency.

In the embodiments provided by the present invention, one color channel is allocated for each risk value parameter. The risk value parameters of the security risk value of online payments are distinguished by colors (RGB). The trust risk degree is represented by R (red); the strange degree is represented by G (green); and the limit is represented by B (Blue).

A chromatography range used by a color code converter may be at RGB 24 bit, with representation values from #000000H to #FFFFFFH, 000,000,000-255,255,255 (16,777,216 color True Color/SVGA). If the system needs higher resolution, RGB 32 bit may also be used. In the embodiments provided by the present invention, a chromatography range of RGB 24 bit is taken as an example, i.e., a brightness value of each color channel ranges from 000 to 255.

S2: During payment, a brightness value of each color channel is calculated according to payment information, and payment prewarning is performed when the brightness value of a color channel is greater than a set security risk value.

The step that, during payment, a brightness value of each color channel is calculated according to payment information, and payment prewarning is performed when the brightness value of a color channel is greater than a set security risk value specifically comprises the following steps:

S21: During payment, a brightness value of the color channel corresponding to the limit is determined according to a payment amount, and the payment amount is displayed by a color corresponding to the brightness value of the color channel.

In the embodiments provided by the present invention, the limit is represented by B. The blue axis B=0 is black, and the blue axis B=1 is true blue. Online payment has been already a part of everyone's life. However, the online payment also increases potential security risks while providing convenience. It is overpaid by one hundred times the amount or more due to a careless mistake such as a mistake in the position of the decimal point, or a mistake of adding a few of extra “0”, or a misunderstanding that the last two digits of the system are “jiao” and “fen” in the system. For example, it is originally supposed to pay twenty yuan fifty cents (¥20.50), and “2050” is entered on a payment interface. However, two thousand fifty yuan (¥2050) is expensed without the default decimal point.

There is also the possibility on an interface for two-dimensional bar code payment that one hundred times the amount or more is collected since a cashier accidentally misplaced the decimal point, or typed extra “0”, or misunderstood that the last two digits of the system were “jiao” or “fen”.

In the method for displaying the security risk value of online payment by color provided by the present invention, during payment, small-value pay/payment and large-value pay/payment are distinguished by clear colors according to a payment amount. The step that, during payment, a brightness value of the color channel corresponding to the limit is determined according to a payment amount, and the payment amount is displayed by a color corresponding to the brightness value of the color channel specifically comprises the following steps:

S211: A small-value deal amount threshold and a large-value deal amount threshold are preset.

S212: A payment amount of a user is acquired when the user pays; if the payment amount is less than the small-value deal amount threshold, it is indicated that the brightness value of the color channel corresponding to the limit is 0; if the payment amount is greater than the large-value deal amount threshold, it is indicated that the brightness value of the color channel corresponding to the limit is 255.

Otherwise, step S213 is executed.

S213: The brightness value of the color channel corresponding to the limit is calculated by using the following formula:

$$B 1 = \frac{P}{H} \times ( M 1 - T 1 ) ;$$

where B1 is the brightness value of the color channel corresponding to the limit; P is the payment amount; H is the large-value deal amount threshold; M1 is the maximum value of the brightness value of the color channel corresponding to the limit; and T1 is the minimum value of the brightness value of the color channel corresponding to the limit.

S214: The payment amount is displayed by the color corresponding to the brightness value of the color channel.

In the embodiments provided by the present invention, the following steps are further included:

if the brightness value of the color channel of the limit corresponding to the payment amount is greater than the large-value deal amount threshold, prewarning reminding is performed on a payment interface. The prewarning reminding may be one or two of characters and speeches.

Specifically, the user may customize a small-value pay/payment limit (the small-value deal amount threshold) according to a security need and a daily payment environment. For example, if the small-value deal amount threshold is 100 yuan, amounts below 100 yuan belong to small-value pay and payment. In the embodiments provided by the present invention, when the payment amount is less than 100 yuan, black (B=0) is the color for two-dimensional bar codes of small-value pay and payment.

The user may also customize a large-value pay/payment limit (the large-value deal amount threshold) according to a security need and a daily payment environment. For example, if the large-value deal amount threshold is 2000 yuan, amounts above (including) 2000 yuan belong to large-value pay and payment. In the embodiments provided by the present invention, when the payment amount is greater than 2000 yuan, true blue (B=1) is the color for two-dimensional bar codes of large-value pay and payment.

When the payment amount is between 100 yuan and 2000 yuan, the brightness value of the color channel is calculated according to the brightness value formula of the color channel corresponding to the above-mentioned calculated limit. The corresponding color is found according to the brightness value of the color channel, and the payment amount and a corresponding payment two-dimensional bar code are displayed by this color. This process can avoid, to a certain extent, a payment security problem caused by mis-operations.

S22: After the payment amount is confirmed, brightness values of the color channels corresponding to the trust risk degree and the strange degree are respectively determined, and the trust risk degree and the strange degree are respectively displayed by colors corresponding to the brightness values of the color channels.

The step that a brightness value of the color channel corresponding to the trust risk degree is determined specifically comprises the following steps:

acquiring real name authentication time and a historical number of complaints of a payee;

calculating the trust risk degree of payment according to the real name authentication time and the historical number of complaints of the payee by using the following formula:

$$R = ( 1 - V ) \times {Q}_{V} + \frac{T}{2} \times {Q}_{T} ;$$

where R is the trust risk degree; V is a real name authentication value; Q_{V} is a weight value of the real name authentication value; T is the historical number of complaints; and Q_{T} is a weight value of the historical number of complaints; and

calculating the brightness value of the color channel corresponding to the trust risk degree:

R1=R×(M2−T2);

where R1 is the brightness value of the color channel corresponding to the trust risk degree; R is the trust risk degree; M2 is a maximum value of the brightness value of the color channel corresponding to the trust risk degree; and T2 is a minimum value of the brightness value of the color channel corresponding to the trust risk degree.

Specifically, the trust risk degree is represented by R. The red axis R=0 is black, and the red axis R=1 is true red. The payment security may be determined from a server by determining, by means of a network, whether a payee has completed real name authentication, and whether the payee has been complained. If a user of the other party has completed the real name authentication and has not been complained, the trust risk degree is secure, which is displayed by R=0 in black. If a user of the other party has been repeatedly complained and has not completed the real name authentication, the user's security level data has been at an extremely insecure level, and the trust risk degree is R=1, displayed in red.

It is defined here: the value of the trust risk degree is from 0 to 1 (0 for low trust risk and 1 for high trust risk), and a real name authentication value is V=Fv (the payee). If the payee has not completed real name authentication, V=0, or, the value of V will increase according to the time of the real name authentication, and the maximum value is 1.

The real name authentication value is a function related to the real name authentication time of the payee. The Fv( ) formula may be optimized according to big data experiments. In the embodiments provided by the present invention, Fv( ) is set to be a piecewise function. When the real name authentication time is longer than or equal to 3 years, V=1; when the real name authentication time is shorter than 3 years and longer than or equal to 1 year, V=0.75; when the real name authentication time is shorter than 1 year and longer than or equal to 0.5 years, V=0.5; and when the real name authentication time is shorter than 0.5 years, V=0.25.

For a complaint record (the historical number of complaints) T=Ft (the payee), it is determined whether the payee has been complained; if the payee has not been complained, T=0; if the payee has been complained once, T=1; if the payee has been complained for multiple times, T=2.

$$R = ( 1 - V ) \times {Q}_{V} + \frac{T}{2} \times {Q}_{T} .$$

The trust risk degree is 2 In one of the embodiments provided by the present invention, it is set Q_{V}=0.5 and Q_{T}=0.5, i.e., a real name authentication weight accounts for 50%, and a complaint record weight accounts for 50%. In practice, the weight values Q_{T} and Q_{V} may be optimized according to big data experiments.

The RGB 24 bit color representation value of the trust risk degree (i.e., the brightness value of the color channel corresponding to the trust risk degree) is

$$R 1 = ( ( 1 - V ) \times {Q}_{V} + \frac{T}{2} \times {Q}_{T} ) \times 255.$$

Later, the trust risk degree is displayed by the color corresponding to the brightness value of the color channel to remind the user of a security risk of the current payment.

In addition, the step that a brightness value of the color channel corresponding to the strange degree is determined specifically comprises the following steps:

S221: A first familiarity a is acquired according to an affinity between the payer and the payee, wherein in the embodiments of the present invention, the affinity between the payer and the payee is determined by means of a social software kind that the payer and the payee are friends in their contacts. The following formula is used for calculation:

$$a = \frac{{\sum }_{i = 1}^{N} {S}_{i} \times {Q}_{i}}{{\sum }_{i = 1}^{N} {Q}_{i}} ;$$

where a is the first familiarity; N is a total number of kinds of social software that the payer and the payee are friends in contacts; Sᵢ is the affinity between the payer and the payee in the ith kind of social software, in the embodiments provided by the present invention, the affinity between the payer and the payee in the ith kind of social software is determined by whether the payee is a friend in contacts of the payer; and Qᵢ is a weight value of the ith kind of social software.

Specifically, the strange degree is represented by G. The green axis G=0 is black, and the green axis G=1 is true green. The affinity may be determined according to whether the payee is on mobile phone contacts, WeChat contacts, Taobao contacts, Alipay contacts, QQ contacts, etc., of the user, and whether the payee has a past payment record.

It is defined here: values of both the strange degree and the familiarity are 0 to 1; and the strange degree=1−familiarity, i.e., 0<strange degree<1 AND 0<familiarity<1 AND strange degree=1−familiarity.

The familiarity is determined according to whether the payee is on the contacts of various kinds of social software and whether the payee has a past payment record. A calculation method for the familiarity is as follows:

The familiarity comprises a first familiarity a and a second familiarity b. The first familiarity a refers to whether the payee is on the contacts of various social software, and the second familiarity b refers to whether the payer has a past payment record.

A calculation method for the first familiarity a is as follows:

S₁=f1 (mobile phone contacts, payee); if the payee is on the mobile phone contacts, S₁=1, or S₁=0;

S₂=f1 (WeChat contacts, payee); if the payee is on the WeChat contacts,

S₂=1, or S₂=0;

S₃=f1 (Alipay contacts, payee); if the payee is on the Alipay contacts, S₃=1, or S₃=0;

S₄=f1 (QQ contacts, payee); if the payee is on the QQ contacts, S₄=1, or S₄=0;

. . .

S_{N}=fN (other suitable software contacts, payee); if the payee is on other suitable software contacts, S_{N}=1, or S_{N}=0;

With the development of social networking services and the increase of payment platforms, the number of the kinds of social software also increases. N is not specifically limited here, and the kinds of social software may be expanded according to needs.

In order to distinguish different possible importance of each contacts, one weight value Qᵢ is defined for each contacts. Commonly, the mobile phone contacts is the most important for users, so that Qᵢ corresponding to the mobile phone contacts S₁ should be weighted; the WeChat contacts and the Alipay contacts are less important; and the QQ contacts and other software contacts are much less important.

Supposing Q₁=2; Q₂=2; Q₃=4; Q₃=4 . . . Q_{N}, in practice, the weight value Qᵢ may be optimized according to big data experiments,

and the first familiarity a=(S₁×Q₁+S₂×Q₂+S₃×Q₃+S₄×Q₄+ . . . +S_{N}×Q_{N})/(Q₁+Q₂+Q₃+Q₄+ . . . +Q_{N}).

S222: A second familiarity b is acquired according to a payment record of the payer.

The second familiarity b is a function related to the payer and the number of payments of the payer. The function related to the payer and the number of payments of the payer may be mined and set according to historical data and a need for secure payment. In the embodiments provided by the present invention, calculation for the second familiarity b is as follows:

b=f (payment record, payer); if there was a payment record of the payer, b=1, or b=0.

S223: A strange degree G is calculated according to the first familiarity and the second familiarity by using the following formula:

G=1−(a×Qa+b×Qb).

where G is the strange degree; a is the first familiarity; Qa is a weight value of the first familiarity; b is the second familiarity; and Qb is a weight value of the second familiarity.

Specifically, values of both the first familiarity a and the second familiarity b are greater than or equal to 0 and less than or equal to 1. In order to make a combined familiarity also greater than or equal to 0 and less than or equal to 1, the weight values Qa and Qb must be introduced.

In one of the embodiments provided by the present invention, supposing Qa=0.5, Qb=0.5 (i.e., whether the payee is on the contacts accounts for 50%, and whether the payee has the payment record accounts for 50%), in practice, Qa and Qb may be optimized according to big data experiments,

the familiarity=first familiarity×Qa+second familiarity×Qb=a×Qa+b×Qr, and the strange degree=1−familiarity.

The specific embodiment of step S221 is taken as an example, the strange degree=1−((Sᵢ×Q₁+S₂×Q₂+S₃×Q₃+S₄×Q₄+ . . . +S_{N}×Qₙ)/(Q₁+Q₂+Q₃+Q₄ . . . +Q_{N}))×Qa+b×Qb))

S224: The brightness value of the color channel corresponding to the strange degree is calculated by using the following formula:

G1=G×(M3−T3).

where G1 is the brightness value of the color channel corresponding to the strange degree; G is the strange degree; M3 is a maximum value of the brightness value of the color channel corresponding to the strange degree; and T3 is a minimum value of the brightness value of the color channel corresponding to the strange degree.

The specific embodiment of step S221 is taken as an example, and the RGB 24 bit color representation value of the strange degree (i.e., the brightness value of the color channel corresponding to the strange degree) is G1=(1−(((S₁×Q₁+S₂×Q₂+S₃×Q₃+S₄×Q₄++S_{N}×Q_{N})/(Q₁+Q₂+Q₃+Q₄+ . . . +Q_{N}))×Qa+b×Qb))×255.

S23: The brightness values of the color channels corresponding to the limit, the trust risk degree and the strange degree are compared with the set security risk value, and when the brightness values of the color channels are greater than the set security risk value, payment prewarning is performed.

Detailed description is made through one specific embodiment below:

The trust risk degree (R, 0 to 1; RGB 24 bit color representation value from 0 to 255) is determined according to whether the payee has completed real name authentication and whether the payee has been complained. An exemplary preset value here is 0.3, and the RGB color representation value (the brightness value of the color channel corresponding to the trust risk degree) is R1=77. That is, a security risk value set for the trust risk degree is 77.

For example, if a payee has completed real name authentication for shorter than 1 year, but longer than or equal to 0.5 years, and has not been complained, the value of the trust risk degree is calculated according to Fv( ) that is the piecewise function in the embodiment in step S22 as:

(1−0.5)×0.5+0/2×0.5=0.25: less than the preset trust risk degree of 0.3;
if a payee has not completed real name authentication, but has not been complained, the trust risk degree value is:

X0.5+0/2X0.5=0.5: greater than the preset trust risk degree of 0.3.

The strange degree (G, 0 to 1; RGB 24 bit color representation value from 0 to 255): the familiarity/strange degree is determined according to whether the payee is on mobile phone contacts, WeChat contacts, Taobao contacts, Alipay contacts, QQ contacts, etc., of the user. An exemplary preset value here is 0.3, and the RGB color representation value (the brightness value of the color channel corresponding to the strange degree) is G1=77.

For example, if one payee is only on the mobile phone contacts, and has one piece of payment record, according to the embodiment in step S221 that is taken as an example, the strange degree value is:

1−(((1×4+0×2+0×2+0×1+0×1)/(4+2+2+1+1))×0.5+1×0.5)=0.3: equal to the preset strange degree value.

The limit (B, 0 to 1; RGB 24 bit color representation value from 0 to 255) is according to a ratio of a payment limit to a preset total limit of an account. An exemplary preset value here is 0.3, and the RGB color representation value (the brightness value of the color channel corresponding to the limit) is B=77.

It is indicated that a preset security alert level triangle is RGB=(77, 77, 77), greyish-green. Three dimensions of the preset security alert level may be changed according to service experiences or via big data analysis. The preset value RGB=(77, 77, 77) here is for demonstration only and has no special meaning.

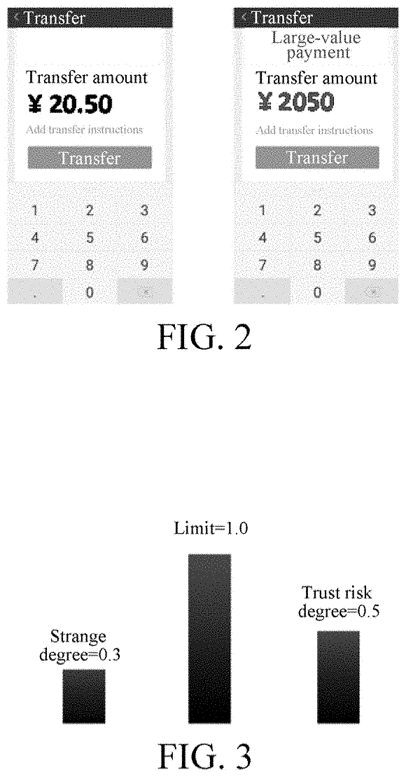

When the user scans a merchant's or transfer two-dimensional bar code by means of mobile phone payment software to enter a payment interface, the user firstly enters a payment amount; when the payment amount is an amount of small-value payment and below, the amount displayed on the interface is black; and when the amount entered exceeds an amount of large-value payment, the amount displayed on the interface is blue. As shown in FIG. 2, if the user enters “20.50” (twenty yuan fifty cents), the amount on the interface is displayed as “20.50” in black; and if the user enters “2050” (two thousand fifty yuan), the amount on the interface is displayed as “¥2050” in blue, indicating large-value payment. The advantages of this mechanism are easy to realize, and the mechanism is clear for users, and plays a role in guaranteeing the security of an online payment account of the user.

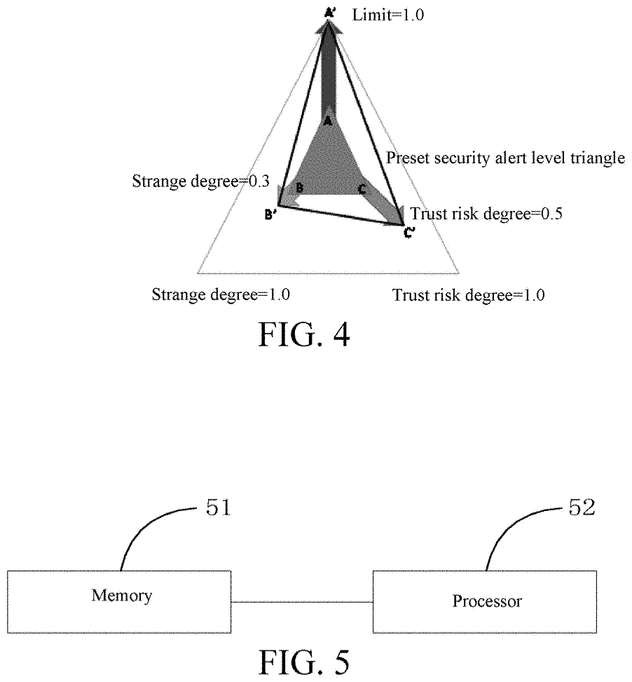

When the user confirms that the large-value payment is normal, transfer is confirmed. This mechanism will check the security risk value of the merchant or payee with its two-dimensional bar code scanned, determine a trust degree matching value according to whether the payee has completed real name authentication and whether the payee has been complained, and determine a strange degree matching value according to whether the payee is on the mobile phone contacts, the WeChat contacts, the Taobao contacts, the Alipay contacts, and the QQ contacts of the user; and finally, the security risk values (as shown in FIG. 3) and the security risk triangle A′, B′, C′ (as shown in FIG. 4) of the payee are displayed by color according to the trust degree, the strange degree and the limit.

When any angle of the security risk triangle A′, B′, C′ of the payee is displayed outside the preset security alert level triangle A, B, C, this mechanism will warn that the current payment transaction has high risk, and the user needs to confirm whether to conduct the risky transaction.

In the embodiments provided by the present invention, as shown in FIG. 3, the brightness value of the color channel corresponding to each risk value parameter is displayed on the payment interface by means of a color bar.

The present invention further provides a system for displaying a security risk value of online payment by color. As shown in FIG. 5, the system comprises a processor 52 and a memory 51 that stores an instruction executable in the processor 52.

The processor 52 may be a general-purpose processor, such as a central processing unit (CPU), may also be a digital signal processor (DSP) and an application-specific integrated circuit (ASIC), or is configured to be one or more integrated circuits that implement the embodiments of the present invention.

The memory 51 is configured to store program code, and transfer the program code to the CPU. The memory 51 may include a volatile memory, for example, a random access memory RAM. Alternatively, the memory 51 may include a non-volatile memory, for example, a read-only memory ROM, a flash memory, a hard disk drive, or a solid state disk. Alternatively, the memory 51 may include a combination of the foregoing types of memories.

Specifically, the system for displaying a security risk value of online payment by color provided by the embodiments of the present invention comprises the processor 52 and the memory 51. The memory 51 stores a computer program operable on the processor 52. The computer program, when executed by the processor 52, realizes the following steps:

acquiring a risk value parameter of an online payment risk value, and allocating one color channel for each risk value parameter; and

during payment, calculating a brightness value of each color channel according to payment information, and

performing payment prewarning when the brightness value of a color channel is greater than a set security risk value.

The computer program, when executed by the processor 52, realizes the following step:

the risk value parameter including a trust risk degree, a strange degree and a limit.

During payment, a brightness value of each color channel is calculated according to payment information, and payment prewarning is performed when the brightness value of a color channel is greater than a set security risk value. The computer program, when executed by the processor 52, realizes the following steps:

during payment, determining a brightness value of the color channel corresponding to the limit according to a payment amount, and displaying the payment amount by a color corresponding to the brightness value of the color channel;

after the payment amount is confirmed, respectively determining brightness values of the color channels corresponding to the trust risk degree and the strange degree, and respectively displaying the trust risk degree and the strange degree by colors corresponding to the brightness values of the color channels; and

comparing the brightness values of the color channels corresponding to the limit, the trust risk degree and the strange degree with the set security risk value, and when the brightness values of the color channels are greater than the set security risk value, performing payment prewarning.

During payment, a brightness value of the color channel corresponding to the limit is determined according to a payment amount, and the payment amount is displayed by a color corresponding to the brightness value of the color channel. The computer program, when executed by the processor 52, realizes the following steps:

presetting a small-value deal amount threshold and a large-value deal amount threshold;

acquiring a payment amount of a user; if the payment amount is less than the small-value deal amount threshold, indicating that the brightness value of the color channel corresponding to the limit is a minimum value; if the payment amount is greater than the large-value deal amount threshold, indicating that the brightness value of the color channel corresponding to the limit is a maximum value; otherwise, calculating the brightness value of the color channel corresponding to the limit by using the following formula:

$$B 1 = \frac{P}{H} \times ( M 1 - T 1 ) ;$$

where B1 is the brightness value of the color channel corresponding to the limit; P is the payment amount; H is the large-value deal amount threshold; M1 is the maximum value of the brightness value of the color channel corresponding to the limit; and T1 is the minimum value of the brightness value of the color channel corresponding to the limit; and

displaying the payment amount by the color corresponding to the brightness value of the color channel.

The computer program, when executed by the processor 52, further realizes the following step:

if the brightness value of the color channel of the limit corresponding to the payment amount is greater than the large-value deal amount threshold, performing prewarning reminding on a payment interface, wherein the prewarning reminding is one or two of characters and speeches.

The computer program, when executed by the processor 52, realizes the following step:

when a two-dimensional bar code is used for payment, displaying a payment two-dimensional bar code by the color corresponding to the brightness value of the color channel.

During determination of the brightness value of the color channel corresponding to the trust risk degree, the computer program, when executed by the processor 52, realizes the following steps:

acquiring real name authentication time and a historical number of complaints of a payee;

calculating the trust risk degree of payment according to the real name authentication time and the historical number of complaints of the payee by using the following formula:

$$R = ( 1 - V ) \times {Q}_{V} + \frac{T}{2} \times {Q}_{T} ;$$

where R is the trust risk degree; V is a real name authentication value; Q_{V} is a weight value of the real name authentication value; T is the historical number of complaints; and Q_{T} is a weight value of the historical number of complaints; and

calculating the brightness value of the color channel corresponding to the trust risk degree:

R1=R×(M2−T2);

where R1 is the brightness value of the color channel corresponding to the trust risk degree; R is the trust risk degree; M2 is a maximum value of the brightness value of the color channel corresponding to the trust risk degree; and T2 is a minimum value of the brightness value of the color channel corresponding to the trust risk degree.

During determination of the brightness value of the color channel corresponding to the strange degree, the computer program, when executed by the processor 52, realizes the following steps:

acquiring a first familiarity according to an affinity between the payer and the payee;

acquiring a second familiarity according to a payment record of the payer;

calculating a strange degree according to the first familiarity and the second familiarity by using the following formula:

G=1−(a×Qa+b×Qb).

where G is the strange degree; a is the first familiarity; Qa is a weight value of the first familiarity; b is the second familiarity; and Qb is a weight value of the second familiarity; and

calculating the brightness value of the color channel corresponding to the strange degree.

The computer program, when executed by the processor 52, realizes the following step:

acquiring a first familiarity according to an affinity between a payer and a payee by using the following formula for calculation:

$$a = \frac{{\sum }_{i = 1}^{N} {S}_{i} \times {Q}_{i}}{{\sum }_{i = 1}^{N} {Q}_{i}} ;$$

where a is the first familiarity; N is a total number of kinds of social software that the payer and the payee are friends in contacts; Sᵢ is the affinity between the payer and the payee in the ith kind of social software, in the embodiments provided by the present invention, the affinity between the payer and the payee in the ith kind of social software is determined by whether the payee is a friend in contacts of the payer; and Qᵢ is a weight value of the ith kind of social software.

An embodiment of the present invention further provides a computer readable storage medium. The computer-readable storage medium here stores one or more programs. The computer-readable storage medium may include a volatile memory, such as a random access memory. The memory may also include a non-volatile memory, such as a read-only memory, a flash memory, a hard disk, or a solid-state disk. The memory may also include a combination of the aforementioned types of memories. The one or more programs in the computer-readable storage medium are executable by one or more processors to realize part or all steps used to realize the above method for displaying a security risk value of online payment by color in the previously described method embodiment.

The method and system for displaying a security risk value of online payment by color provided by the present invention are described in detail above. Any obvious modification made on the invention by a person of ordinary skill in the art without departing from the essentials of the invention will constitute a patent infringement of the invention, and a person of ordinary skill in the art is to undertake corresponding legal liability.

What is claimed is:

1. A method for displaying a security risk value of online payment by color, comprising the following steps:
acquiring a risk value parameter of an online payment risk value, and allocating one color channel for each risk value parameter; and
during payment, calculating a brightness value of each color channel according to payment information, and
performing payment prewarning when the brightness value of a color channel is greater than a set security risk value.

2. The method for displaying the security risk value of online payment by color according to claim 1, wherein
the risk value parameter comprises a trust risk degree, a strange degree, and a limit.

3. The method for displaying the security risk value of online payment by color according to claim 2, wherein the during payment, calculating a brightness value of each color channel according to payment information, and performing payment prewarning when the brightness value of a color channel is greater than a set security risk value comprises the following steps:
during payment, determining a brightness value of the color channel corresponding to the limit according to a payment amount, and displaying the payment amount by a color corresponding to the brightness value of the color channel;
after the payment amount is confirmed, respectively determining brightness values of the color channels corresponding to the trust risk degree and the strange degree, and respectively displaying the trust risk degree and the strange degree by colors corresponding to the brightness values of the color channels; and
comparing the brightness values of the color channels corresponding to the limit, the trust risk degree and the strange degree with the set security risk value, and when the brightness values of the color channels are greater than the set security risk value, performing payment prewarning.

4. The method for displaying the security risk value of online payment by color according to claim 3, wherein the during payment, determining a brightness value of the color channel corresponding to the limit according to a payment amount, and displaying the payment amount by a color corresponding to the brightness value of the color channel comprises the following steps:
presetting a small-value deal amount threshold and a large-value deal amount threshold;
acquiring a payment amount of a user; if the payment amount is less than the small-value deal amount threshold, indicating that the brightness value of the color channel corresponding to the limit is a minimum value; if the payment amount is greater than the large-value deal amount threshold, indicating that the brightness value of the color channel corresponding to the limit is a maximum value; otherwise,
calculating the brightness value of the color channel corresponding to the limit by using the following formula:
$$B 1 = \frac{P}{H} \times ( M 1 - T 1 ) ;$$
wherein B1 is the brightness value of the color channel corresponding to the limit; P is the payment amount; H is the large-value deal amount threshold; M1 is the maximum value of the brightness value of the color channel corresponding to the limit; and T1 is the minimum value of the brightness value of the color channel corresponding to the limit; and
displaying the payment amount by the color corresponding to the brightness value of the color channel.

5. The method for displaying the security risk value of online payment by color according to claim 4, further comprising the following steps:
if the brightness value of the color channel of the limit corresponding to the payment amount is greater than the large-value deal amount threshold, performing prewarning reminding on a payment interface, wherein
the prewarning reminding is one or two of characters and speeches.

6. The method for displaying the security risk value of online payment by color according to claim 4, wherein
when a two-dimensional bar code is used for payment, displaying a payment two-dimensional bar code by the color corresponding to the brightness value of the color channel.

7. The method for displaying the security risk value of online payment by color according to claim 3, the determining a brightness value of the color channel corresponding to the trust risk degree comprises the following steps:
acquiring real name authentication time and a historical number of complaints of a payee;
calculating the trust risk degree of payment according to the real name authentication time and the historical number of complaints of the payee by using the following formula:
$$R = ( 1 - V ) \times {Q}_{V} + \frac{T}{2} \times {Q}_{T} ;$$
wherein R is the trust risk degree; V is a real name authentication value; Q_{V} is a weight value of the real name authentication value; T is the historical number of complaints; and Q_{T} is a weight value of the historical number of complaints; and
calculating the brightness value of the color channel corresponding to the trust risk degree:
R1=R×(M2−T2);
wherein R1 is the brightness value of the color channel corresponding to the trust risk degree; R is the trust risk degree; M2 is a maximum value of the brightness value of the color channel corresponding to the trust risk degree; and T2 is a minimum value of the brightness value of the color channel corresponding to the trust risk degree.

8. The method for displaying the security risk value of online payment by color according to claim 3, the determining a brightness value of the color channel corresponding to the strange degree comprises the following steps:
acquiring a first familiarity according to an affinity between a payer and a payee;
acquiring a second familiarity according to a payment record of the payer;
calculating a strange degree according to the first familiarity and the second familiarity by using the following formula:
G=1−(a×Qa+b×Qb);
wherein G is the strange degree; a is the first familiarity; Qa is a weight value of the first familiarity; b is the second familiarity; and Qb is a weight value of the second familiarity; and
calculating the brightness value of the color channel corresponding to the strange degree.

9. The method for displaying the security risk value of online payment by color according to claim 8, wherein in the acquiring a first familiarity according to an affinity between the payer and the payee, the following formula is used for calculation:
$$a = \frac{{\sum }_{i = 1}^{N} {S}_{i} \times {Q}_{i}}{{\sum }_{i = 1}^{N} {Q}_{i}} ;$$
wherein a is the first familiarity; N is a total number of kinds of social software that the payer and the payee are friends in contacts; Sᵢ is the affinity between the payer and the payee in the ith kind of social software, in the embodiments provided by the present invention, the affinity between the payer and the payee in the ith kind of social software is determined by whether the payee is a friend in contacts of the payer; and Qᵢ is a weight value of the ith kind of social software.

10. A system for displaying a security risk value of online payment by color, comprising a processor and a memory, wherein the memory stores a computer program operable on the processor; and the computer program, when executed by the processor, realizes the following steps:
acquiring a risk value parameter of an online payment risk value, and allocating one color channel for each risk value parameter; and
during payment, calculating a brightness value of each color channel according to payment information, and
performing payment prewarning when the brightness value of a color channel is greater than a set security risk value.
